(19) United States
(12) Patent Application Publication
(10) Pub. No.: US 2020/0126125 A1
(43) Pub. Date: Apr. 23, 2020

(54) AUTOMATED DELIVERY OF TEMPORALLY LIMITED TARGETED OFFERS

(71) Applicant: Intel Corporaation, Santa Clara, CA (US)

(72) Inventors: Addicam V. SANJAY, Gilbert, AZ (US); Jose A. AVALOS, Chandler, AZ (US); Shao-Wen YANG, San Jose, CA (US); Ke-Yu CHEN, San Jose, CA (US); Chieh-Yih WAN, Beaverton, OR (US); Rahul SHAH, San Francisco, CA (US); Ryan W. PARKER, Phoenix, AZ (US); Shailesh CHAUDHRY, Chandler, AZ (US); Michael G. MILLSAP, Chandler, AZ (US); Daniel GUTWEIN, Phoenix, AZ (US)

(73) Assignee: Intel Corporation, Santa Clara, CA (US)

(21) Appl. No.: 16/618,712

(22) PCT Filed: Jun. 30, 2017
(86) PCT No.: PCT/US2017/040434

§ 371 Date: Dec. 2, 2019

(51) Int. Cl. G06Q 30/02

(52) U.S. Cl. CPC G06Q 30/0267; G06Q 30/0264

(57) ABSTRACT

Systems and methods for autonomously generating temporally limited targeted offers and/or directed advertisements based on detected interaction between customers and products are provided. A regional monitoring system may detect the movement of a customer in the establishment. A customer that moves within a limited area of the establishment may be identified by targeted offer distribution circuitry as interested in one or more products in the area. A customer interest monitoring device detects interaction between the customer and the product. Using information obtained from the customer interest monitoring device, the targeted offer distribution circuitry autonomously generates a temporally limited targeted offer or directed advertisement. The targeted offer distribution circuitry delivers the targeted offer or directed advertisement to an output device proximate the customer or to a processor-based device or media carried or possessed by the customer.

### TECHNICAL FIELD

The present disclosure relates to the delivery of targeted advertising.

### BACKGROUND

Retail sales increasing trend away from traditional brick-and-mortar establishments and towards online marketplaces such as Jet.com, Amazon.com, and eBay.com. The ubiquity of the Internet capable devices, such as smartphones, and the ability to have a product delivered to your front door within days provides an attractive combination for many customers. With the change in purchasing habits, brick-and-mortar retailers increasingly find themselves in the position of product showrooms that provide customers the opportunity to examiner a product firsthand prior to placing an order for the product online.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A is a plan view of an illustrative automated targeted offer delivery system that includes an establishment apportioned into one or more; one or more regional monitoring systems capable of tracking customers in a region; one or more object displays; one or more offer output devices; one or more customer interest monitoring devices; and targeted offer distribution circuitry, in accordance with at least one embodiment described herein;

FIG. 1B is a schematic of an illustrative automated targeted offer delivery system within the designated portion of FIG. 1A, that includes three shelves holding fungible products, each of the shelves includes a respective customer interest monitoring device, in accordance with at least one embodiment described herein.

FIG. 2 is a perspective view of an illustrative automated targeted offer delivery system in an example retail setting that includes a first display having a first output device, a second display having a second output device, a regional monitoring system, a plurality of customer interest monitoring devices and targeted offer distribution circuitry, in accordance with at least one embodiment described herein;

FIG. 3 is an input/output (I/O) diagram of illustrative targeted offer distribution circuitry, in accordance with at least one embodiment described herein;

FIG. 4 is a block diagram of an illustrative targeted offer distribution system that includes a regional monitoring system, a customer interest monitoring device, and an output device communicably coupled to a processor-based device via a network, in accordance with at least one embodiment described herein;

FIG. 5 is a high-level logic flow diagram of an illustrative targeted offer distribution method, in accordance with at least one embodiment described herein;

FIG. 6 is a system-level flow diagram of an illustrative customer/product interaction tracking system, in accordance with at least one embodiment described herein; and

FIG. 7 is a system-level flow diagram of an illustrative product pricing system in which the targeted offer distribution circuitry uses customer information, product information, and the customer's interaction with a product to determine a personalized targeted offer or directed advertisement for the product, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The systems and methods disclosed herein provide automated generation of directed advertising and/or targeted offers based on detected customer interaction with products in a retail sales environment. Upon autonomously detecting customer interest in one or more products, the systems and methods described herein will autonomously generate and deliver a targeted offer to the customer. The system and methods described herein will deliver the targeted offer to digital signage or a processor based device that is either possessed by or proximate the customer. The targeted offer is of relatively short temporal duration to reduce the possibility of competitive shopping with online retailers and to induce the customer to remain in the brick-and-mortar retailer location and “close the deal” to receive the promotional offer by purchasing or otherwise acquiring the product of interest. The systems and methods described herein beneficially address the issue of brick-and-mortar retailers simply becoming a product showroom for online retailers. The relatively limited temporal aspect advantageously places limited pressure on the customer to make a rather quick purchase decision minimizing the practice of “price checking” products offered by the brick-and-mortar retailer against similar or identical products offered by online retailers or marketplaces.

The systems and methods described herein may also deliver targeted offers based on information related to customer demographics and/or prior purchases. The systems and methods described herein may uniquely identify a customer using information contained on a radio frequency identification (RFID) tag disposed in a shopper card or similar instrument offered or provided by the retailer and possessed by the customer. The systems and methods described herein may uniquely identify a customer using information contained on a processor-based device, such as a smartphone, possessed by the customer. The demographic information and prior purchase information may be used by the systems and methods described herein to uniquely tailor offers and/or directed advertising to individual customers.

The systems and methods described herein may identify customer interest based on the location of the customer within an establishment. As a customer moves through an establishment, the systems and methods described herein may track the movement and time spent by the customer within various regions of the establishment. The systems and methods described herein may track a customer in an establishment using a first radio frequency technology and various RF signal parameters such as content and/or signal strength, for example the content or strength of an IEEE 802.11 (Wi-Fi®) signal generated by a smartphone possessed by the customer. Such customer tracking may enable the systems and methods described herein beneficially distinguish between customers merely passing through a portion of an establishment and customers who are taking an extended time in one or more portions of an establishment and represent a party for whom a directed advertising and/or a targeted offer has a reasonable chance at persuading the customer to purchase.

The systems and methods described herein may use optical and/or RF signals to detect customer interaction with one or more products included on a display in the establishment. For example, the systems and methods described herein may use still or video image acquisition devices to determine when a customer exhibits behavior indicative of interest in a product. In another example, the systems and methods described herein may use changes in RF signal content, strength, phase, and/or any other measurable signal parameters to detect a customer interacting with an object identifiable using the RF signal. The systems and methods described herein therefore provide a significant and non-trivial solution to maintaining customer interest and encouraging customer purchases in a brick-and-mortar establishment rather than simply treating the brick-and-mortar establishment as a product showroom for a future online purchase.

A targeted offer distribution system is provided. The system may include: a customer interest monitoring device to generate an output signal that includes information indicative of customer browsing of products in a retail environment; an output device; controller circuitry communicably coupled to the customer interest monitoring device and to the display device; and a storage device containing machine-executable instructions, that when executed by the controller circuitry, transform the controller circuitry to targeted offer distribution circuitry, the targeted offer distribution circuitry to: detect customer interaction with one or more products using the information included in the customer interest monitoring device output signal; generate a temporally limited targeted offer based at least in part on the detected customer interaction with the one or more products; and deliver the temporally limited targeted offer to the output device.

A targeted offer distribution method is provided. The method may include: generating an output signal that includes information indicative of customer browsing of products in a retail environment by a customer interest monitoring device; detecting customer interaction with one or more products using the information included in the customer interest monitoring device output signal by targeted offer distribution circuitry communicably coupled to the customer interest monitoring device; generating, by the targeted offer distribution circuitry, a temporally limited offer directed to at least one product based on the detected customer interaction with the one or more products; and delivering the temporally limited offer via an output device communicably coupled to the targeted offer distribution circuitry.

A non-transitory computer-readable medium containing machine-executable instructions is provided. The instructions, when executed by controller circuitry, cause the controller circuitry to transition to targeted offer distribution circuitry, the targeted offer distribution circuitry to: receive an output signal that includes information indicative of customer browsing of products in a retail environment, the output signal generated by a communicably coupled customer interest monitoring device; detect customer interaction with one or more products using the information included in the customer interest monitoring device output signal;

generate a temporally limited offer directed to at least some of the one or more products based on the detected customer interaction with the one or more products; and cause a communicably coupled display device to display the temporally limited offer.

A targeted offer distribution system is provided. The system may include: a means for generating an output signal that includes information indicative of customer browsing of products in a retail environment; a means for detecting customer interaction with one or more products using the information included in the customer interest monitoring device output signal; a means for generating a temporally limited offer directed to at least some of the one or more products based on the detected customer interaction with the one or more products; and a means for delivering the temporally limited offer to the customer.

As used herein the terms “top,” “bottom,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, the term “logically associated” when used in reference to a number of objects, systems, or elements, is intended to convey the existence of a relationship between the objects, systems, or elements such that access to one object, system, or element exposes the remaining objects, systems, or elements having a “logical association” with or to the accessed object, system, or element. An example “logical association” exists between relational databases where access to an element in a first database may provide information and/or data from one or more elements in a number of additional databases, each having an identified relationship to the accessed element. In another example, if “A” is logically associated with “B,” accessing “A” will expose or otherwise draw information and/or data from “B,” and vice-versa.

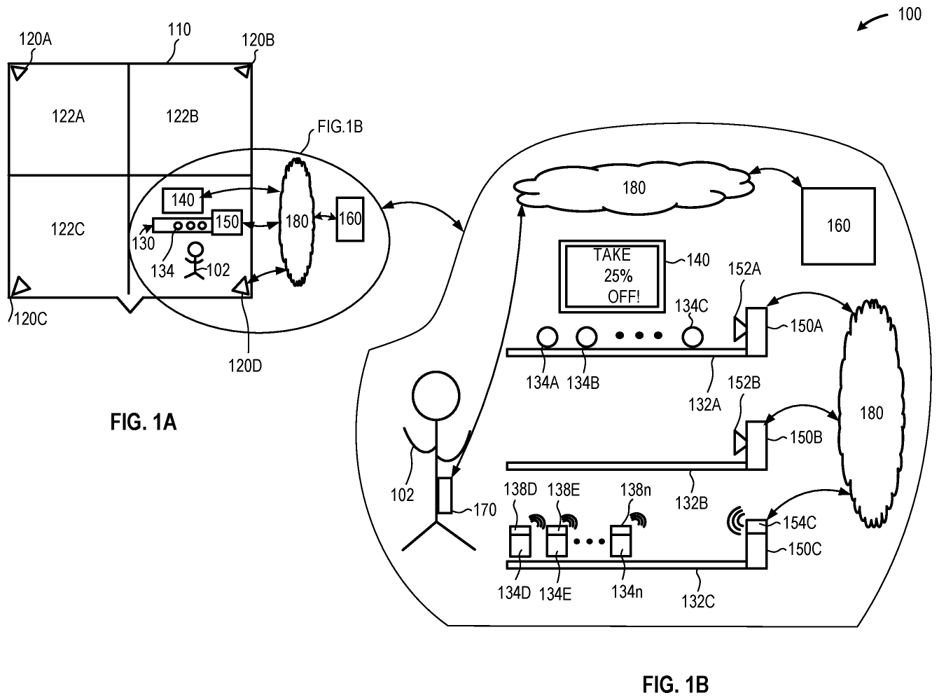

FIG. 1A is a plan view of an illustrative automated targeted offer delivery system 100 that includes an establishment 110 apportioned into one or more 112A-112D (collectively, “regions 112”); one or more regional monitoring systems 120A-120D (collectively, “regional monitoring systems 120”) capable of tracking customers 122 in a region 112; one or more object displays 130; one or more offer output devices 140; one or more customer interest monitoring devices 150A-150C (collectively, “customer interest monitoring devices 150”); and targeted offer distribution circuitry 160, in accordance with at least one embodiment described herein. FIG. 1B is a schematic of an illustrative automated targeted offer delivery system 100 within the designated portion of FIG. 1A, that includes three shelves 132A-132C (collectively, “shelves 132”) holding fungible products 134A-134n (collectively, “products 134”), each of the shelves 132 includes a respective customer interest monitoring device 150A-150C, in accordance with at least one embodiment described herein.

Referring first to FIG. 1A, the targeted offer delivery system 100 may include one or more regional monitoring systems 120 disposed throughout an establishment 110 such that customer movement and/or traffic in, about, or through each region of the establishment 110 may be monitored by the targeted offer distribution circuitry 160. In embodiments, the targeted offer distribution circuitry 160 may detect the location and/or movement of customers 122 in all or a portion of the establishment 110. In some embodiments, the targeted offer distribution circuitry 160 may identify at least a portion of the customers 122 using one or more techniques such as facial recognition, device fingerprinting (e.g., using radio frequency signal strength from one or more transmitters/transceivers, such as Wi-Fi, BLUETOOTH®, or NFC transceivers, disposed in a processor-based device 170 carried by and logically associated with a customer 122), or using proprietary media issued by the establishment (e.g., a shopper's card issued by a supermarket). Using the regional monitoring systems 120, the targeted offer distribution circuitry 160 detects and tracks the movement and dwell time of at least some of the customers 122 in the establishment 110. The targeted offer distribution circuitry 160 is thus able to identify when a customer 102 remains in a single location or repeatedly visits multiple locations within the establishment 110 and may interpret such activity as indicative of a potential interest in a product 134 by the customer 102.

In embodiments, the regional monitoring system 120 may be communicably coupled to one or more storage devices capable of storing or otherwise retaining information and/or data logically associated with an identified customer 102. Such information and/or data may include, but is not limited to, information and/or data associated with previous visits to the establishment 110 by the customer 102. Locations in the establishment 110 where the customer 102 has previously spent time. Products in the establishment 110 previously identified as products of interest 134 to the customer 102. The targeted offer distribution circuitry 160 may use such prior visit information to determine or otherwise detect when a customer 102 demonstrates interest in one or more products 134 offered by the establishment 110. For example, as the customer 102 travels through the establishment 110, the thematic content delivery circuitry 160 may generate targeted offer or directed advertising to a product 134 in which the customer 102 may have expressed a previous interest but had not purchased.

Once, through behavior and/or activity, a customer 102 is identified as demonstrating a level of interest in products 134 in a region, portion, or area of the establishment 110, the targeted offer distribution circuitry 160 may monitor the interaction of the customer 102 on a more granular level using one or more customer interest monitoring devices 150. The customer interest monitoring device 150 provides the targeted offer distribution circuitry 160 information and/or data on the specific products 134 with which the customer 102 interacts. In embodiments, upon detecting customer interaction that is indicative or expressive of a customer interest in a product 134 the targeted offer distribution circuitry 160 may generate directed advertising and/or a targeted offer for the product 134 of interest or for one or more products having a relationship or associated with the product 134 of interest. For example, upon detecting customer interest in oil filters, the targeted offer distribution circuitry 160 may generate a targeted offer and/or directed advertising for additional oil filters (e.g., buy 1^{st} get 2^{nd} at 50% off—the same product 134) or for a related product such as motor oil. In embodiments, the targeted offer distribution circuitry 160 delivers the targeted offer or directed advertising to an output device 140 such as digital signage or a coupon printer/dispenser located proximate the product 134 and/or the customer 102. In other embodiments, the targeted offer distribution circuitry 160 delivers the directed advertising or targeted offer to a processor-based device, such as a smartphone, possessed by and/or associated with the customer 102.

The promotional offer included in the targeted offer or directed advertising delivered to the output device 140 is of limited temporal duration (e.g., Buy 1^{st} get 2^{nd} at 50% off for the next 5 minutes) and/or non-transferrable from the customer 102 to others. The limited temporal duration beneficially provides an incentive for the customer 102 to make an immediate purchase of the product 134 rather than delay the purchase until after checking prices on the same or comparable products at competing online and brick-and-mortar retailers. Thus, the autonomous generation, timely delivery, and short temporal duration of the promotional offers contained in the targeted offer or directed advertising delivered to the output device 140 benefits the customer 102 by offering the customer an incentive and benefits the establishment 110 by providing an incentive for the customer 102 to make an immediate, rather than deferred, purchase.

Referring now to FIG. 1B, the customer 102 is standing proximate a display 130 including three shelves 132A-132C. Respective customer interest monitoring devices 150A-150C monitor the products disposed on the shelves 132. A customer interest monitoring device 150A that includes an image acquisition device 152A monitors the products 134A-134C disposed on the uppermost shelf 132A. A customer interest monitoring device 150B that includes an image acquisition device 152B monitors the middle shelf. A customer interest monitoring device 150C that includes a radio frequency (RF) detector 154C monitors products 134D-134n disposed in the lowermost shelf 132C. Each of products 134D-134n contains or carries a respective tag 138D-138n capable of continuously, intermittently, periodically, or aperiodically emitting an RF signal that is logically associated with and uniquely identifies the product 134, and which is detectable by the RF detector 154C. Although depicted as mounted on shelving, the customer interest monitoring device 150 may be disposed in the establishment 110 at one or more locations proximate the display 130 (in floor, on ceiling, on walls, etc.).

The customer interest monitoring devices 150 communicably couple to the targeted offer distribution circuitry 160 via one or more networks 180. The image acquisition device-based customer interest monitoring devices 150A and 150B communicate information and/or data representative of one or more still or moving images captured or otherwise acquired by the respective image acquisition devices 152A and 152B to the targeted offer distribution circuitry 160. The targeted offer distribution circuitry 160 evaluates the content of received image(s) to detect customer behavior exhibiting or indicative of an interest in one or more products 134 contained in the display 130. Such behaviors may include, but are not limited to, a customer handling the product, the amount of time a customer handles the product, a customer's interaction with product (smelling a food item, putting on a clothing item, swinging a hammer, swinging a golf club, etc.), or combinations thereof. Based on the detected interest in one or more products 134, the targeted offer distribution circuitry 160 may identifies the product 134 using object placement, shape recognition, 2-D or 3-D matrix coding, or similar object identification methods using captured images.

The RF detector 154C may include one or more passive antennas, one or more active readers or interrogators, or any combination thereof. The RF detector 154C communicates information and/or data representative of the received RF data (e.g., received signal strength indicator (RSSI), phase, frequency and timestamp) obtained by the RF detector 154C. Some or all of the products 134D-134n include an RF emitter 138D-138n that is logically associated and uniquely identifies the respective product 134 to which it is attached. When the RF-tagged products 134 remain stationary (e.g., when the products 134 remain untouched on the shelf 132C), the RF data obtained by the RF detector 154C remains relatively consistent. However, when one of the RF-tagged products 134 is moved or displaced (e.g., picked up by a customer 102), the RF data as detected by the RF detector 154C will change. In embodiments, the RF detector 154C may detect and identify which of the RF tagged products 134 on shelf 132C has been displaced.

For example, the RF detector 154C may include a radio frequency identification (RFID) interrogator and each of the products 134 may include a passive RFID tag 138 that, when excited by the RFID interrogator 154C emits a signal containing a unique identifier logically associated with the product 134 to which the RFID tag 138 is attached. As a customer 102 interacts with the product 134, one or more parameters (e.g., the signal strength) of the signal emitted by the RFID tag 138 attached to the product will change. This change in one or more parameters may be used by the targeted offer distribution circuitry 160 to detect customer behavior indicative of customer interest in the product 134.

Once the product of interest 134 to the customer 102 is identified, the targeted offer distribution circuitry 160 generates and communicates a targeted offer or directed advertisement to one or more output devices. In embodiments, the output device that receives the directed advertisement may include, but is not limited to: digital signage 140 disposed proximate the display 130; and/or a processor-based device 170, such as a smartphone, that is carried or otherwise possessed by the customer 102.

The establishment 110 may include any location offering fungible goods, in the form of products 134, to customers 102. Although the subsequent discussion focuses on retail establishments such as grocery stores, clothing stores, and sporting goods stores for convenience and conciseness, such should not exclude the implementation of the systems and methods described herein other establishments offering other types of products 134 to customers 102. The establishment 110 may include one or more regional monitoring systems 120. In embodiments, each of the regional monitoring systems 120 may correspond to and/or monitor customer movement, activity, and/or lingering in a physical portion of the establishment 110. For example, as depicted in FIG. 1A each of the regional monitoring systems 120 corresponds to a quadrant 112A-112D of the establishment 110. In other embodiments, each of the regional monitoring systems 120 may correspond to a department or similar product-related portion of the establishment 110 and may monitor customer activity in the portion of the establishment 110 covered by the respective regional monitoring system 120.

The one or more regional monitoring systems 120 may include any number and/or combination of systems and/or devices capable of providing information and/or data associated with at least some of the customers 102 in the portion of the establishment 110 covered by the respective regional monitoring system 120. Each of the regional monitoring systems 120 generates one or more output signals containing information and/or data associated with customers 102 in the respective portion of the establishment covered by the respective regional monitoring system 120. At least some of the regional monitoring systems 120 may include one or more image acquisition devices, such as one or more charge coupled device (CCD) or complementary metal oxide semiconductor (CMOS) image sensors to generate image data, at least a portion of which is included in the output signal communicated to the targeted offer distribution circuitry 160. At least some of the regional monitoring systems 120 may include one or more audio acquisition devices, such as one or more microphones to generate audio data, at least a portion of which may be included in the output signal communicated to the targeted offer distribution circuitry 160. At least some of the regional monitoring systems 120 may include one or more RF transceivers to transmit and/or receive information and/or data from RFID, near field communication, IEEE 802.11 (Wi-Fi), and/or cellular compatible devices carried or possessed by customers 122 in the establishment 110.

Each of the regional monitoring systems 120 communicates the one or more output signals to the targeted offer distribution circuitry 160 via one or more wired and/or wireless networks 180. The targeted offer distribution circuitry 160 may include one or more applications, programs, or machine-executable instruction sets that use the information and/or data in the output signals to identify and track the movement of customers 102 in the establishment 110. In embodiments, the targeted offer distribution circuitry 160 may include one or more applications, programs, or machine-executable instruction sets that use the information and/or data in the output signals to uniquely identify all or a portion of the customers 102 in the establishment 110. Such unique identification of customers 102 may be achieved using one or more currently available or future developed technologies including, but not limited to, facial recognition, and/or information and/or data obtained from devices carried or possessed by customers 102 in the establishment 110. In embodiments, the targeted offer distribution circuitry 160 may include one or more applications, programs, or machine-executable instruction sets that use the information and/or data in the output signals to identify customers 102 who remain within a defined area or range of one or more products for greater than a defined temporal period. For example, the targeted offer distribution circuitry 160 may identify customers who remain proximate an object or a class of products for longer than 60 seconds. Such lingering near an object or a class of products may be indicative of an interest on the part of the customer 102 in the object or class of products. In embodiments, the targeted offer distribution circuitry 160 may include one or more applications, programs, or machine-executable instruction sets that use the information and/or data in the output signals to identify customers 102 who remain or linger within each of a plurality of areas within the establishment 110 for greater than a defined period of time. For example, the targeted offer distribution circuitry 160 may identify customers who remain or linger in a boys clothing section and a girls clothing section for more than 60 seconds.

The display 130 may include any number and/or combination of structures capable of supporting and displaying products 134. Example, non-limiting, displays include shelves, racks, pegboards, hangers, and similar. Some or all of the displays 130 may include a plurality of shelves 132 or similar structures on which products 134 may be displayed.

The output device 140 may include any number and/or combination of systems and/or devices capable of producing a human-perceptible output. In embodiments, such output may include visual output, audio output, or any combination thereof. In embodiments, the output device 140 may generate or otherwise produce a tangible output, such as a coupon or similar instrument. In embodiments, the output device 140 may include digital signage displayed proximate the products 134 and/or the display 130. In such embodiments, the output device 140 may include digital signage in combination with a ticket printer or similar device capable of producing a tangible output. In embodiments, the output device 140 may include one or more digital signs, shelf tags, or similar programmable devices capable of receiving information and/or data from the targeted offer distribution circuitry 160.

In some implementations, the output device 140 may be disposed in a static location, for example, physically coupled to the display 130 in a location visible to customers viewing the products 134 disposed in, on, or about the display 130. In some implementations, the output device 140 may be disposed on a mobile platform capable of movement in a 2-D or 3-D space defined by the boundaries of the establishment 110. For example, in some implementations, the output device 140 may be disposed on a robot or similar platform capable of movement in a 2-D space defined by the floor of the establishment 110. Such may beneficially permit the robot to approach the customer 102 and present the targeted offer or directed advertising. For example, in some implementations, the output device 140 may include one or more visual and/or audio output devices disposed on a robot or similar platform capable of movement in a 2-D space defined by the floor of the establishment 110. In another example, in some implementations, the output device 140 may include one or more visual and/or audio output devices disposed on a drone or similar platform capable of movement in a 3-D space defined by the interior volume of the establishment 110. Such may beneficially permit the mobile platform to approach the customer 102 and present the targeted offer or directed advertising directly to the customer 102. In such implementations, the targeted offer distribution circuitry 160 may provide the mobile platform instructions and/or data that includes routing instructions to direct the mobile platform to a location proximate the customer 102 prior to delivering the targeted offer or directed advertising.

The output device 140 communicably couples to the targeted offer distribution circuitry 160 via one or more wired or wireless networks 180. The one or more wireless networks 180 may include, but are not limited to, one or more wired or wireless local area networks (LANs); one or more wired or wireless metropolitan area networks (MANs); one or more wired or wireless wide area networks (WANs); one or more wired or wireless worldwide networks (WWANs); or combinations thereof. The one or more wired networks 180 may include, but are not limited to, an IEEE 802.3 (Ethernet) compliant wired network.

The customer interest monitoring devices 150 may include any number and/or combination of systems and/or devices capable of detecting interaction between a customer 102 and one or more products 134 disposed in, on, or about the display 130. The customer interest monitoring devices 150 may include one or more sensors or similar devices capable of detecting the interaction between a customer 102 and one or more products 134. The sensors may include, but are not limited to, one or more optical sensors 152, one or more radio frequency identification readers/interrogators 154, one or more infrared sensors, one or more ultrasonic sensors, or combinations thereof. Each of the customer interest monitoring devices 150 may include one or more wired or wireless network communications interfaces (e.g., a network interface card or NIC) that communicably couple the customer interest monitoring devices 150 to the targeted offer distribution circuitry 160 via the network 180. In some implementations, some or all of the customer interest monitoring devices 150 may communicably couple to a gateway device (not depicted in FIGS. 1A and 1B) communicably coupled to the targeted offer distribution circuitry 160 via one or more wired or wireless networks 180.

Each of the customer interest monitoring devices 150 generates an output signal that includes information and/or data collected by the one or more sensors disposed in the respective customer interest monitoring device 150. In embodiments, the customer interest monitoring devices 150 communicate the output signal to the targeted offer distribution circuitry 160 for analysis to determine whether a customer 102 demonstrates an interest in one or more products 134. In such embodiments, the customer interest monitoring device 150 may transmit the output signal to the targeted offer distribution circuitry 160 on a continuous, intermittent, non-continuous, event-driven (e.g., upon detecting a customer 102 lingering at a product display 130 for more than 10 seconds), periodic, or aperiodic basis.

In other embodiments, the customer interest monitoring device 150 may perform some or all of the analysis to determine whether a customer 102 demonstrates an interest in one or more products 134. In such embodiments, the customer interest monitoring device 150 may generate and communicate and output signal including information and/or data indicative of the customer 102 and the object(s) of interest to the targeted offer distribution circuitry 160 upon detecting a customer interest in one or more products 134.

In embodiments, the customer interest monitoring device 150 may be operably coupled to a power distribution grid and may receive uninterrupted line power. In other embodiments, the customer interest monitoring device 150 may be locally powered using one or more energy storage devices, such as one or more primary or secondary batteries, super-capacitors, or ultra-capacitors. In such embodiments, the customer interest monitoring device 150 may maintain one or more relatively high-power consumption sensors (e.g., image acquisition devices, RFID readers) in an OFF or STANDBY state until a customer 102 is detected and only then (based on the detection event) transition the relatively high power consumption sensors to an ON or ACTIVE state.

As depicted in FIG. 1B, customer interest monitoring devices 150A and 150B include image acquisition devices 152A and 152B, respectively. Customer interest monitoring devices 150A and 150B generate and communicate information and/or data representative of images of one or more shelves 132 to the targeted offer distribution circuitry 160. Using the image information and/or data, the targeted offer distribution circuitry 160 detects customer interest and/or interaction with products 134 disposed on shelf 132A. Such interest may be detected based on an amount of time the customer 102 lingers at the display 130. Such interest may be detected based on the customer picking up and/or examining the product 134. Upon detecting such interest, the targeted offer distribution circuitry 160 generates and communicates a targeted offer or directed advertising to an output device 140 proximate the location of the customer 102 or to a processor-based device 170 carried or possessed by the customer 102.

Also as depicted in FIG. 1B, in embodiments, the customer interest monitoring device 150C may include an RF detector 154C. Customer interest monitoring device 150C generates and communicates information and/or data representative of the RF data provided by the RF tag 158 attached to the respective product of interest to the consumer to the targeted offer distribution circuitry 160. Based on changes in the RF data as customers interact with the RF-tagged products 136, the targeted offer distribution circuitry 160 is able to detect customer interest and/or interaction with one or more products 136. Upon detecting such interest, the targeted offer distribution circuitry 160 generates and communicates a targeted offer or directed advertising to the output device proximate the location of the customer 102 or to a device 170 carried or possessed by the customer 102.

The targeted offer distribution circuitry 160 may include any number and/or combination of systems, circuits, and/or devices capable of executing machine-readable instruction sets and providing the capability to: detect customer interest based at least in part on information and/or data provided by customer interest monitoring devices 150; generate one or more targeted offers or directed advertising based on the detected interaction between a customer 102 and one or more products 134; and communicate the one or more targeted offers or directed advertising to an output device 140 and/or a personal processor-based device 170 in a manner perceptible to the customer 102. The targeted offer distribution circuitry 160 may include one or more single- or multi-core processors, microprocessors, controllers, microcontrollers, or similar. In some implementations, the targeted offer distribution circuitry 160 may include centralized controller circuitry that is communicably coupled to the customer interest monitoring devices 150 via one or more networks 180. In some implementations, the targeted offer distribution circuitry 160 may be distributed among some or all of the customer interest monitoring devices 150. In some implementations, the targeted offer distribution circuitry 160 may be implemented as a cloud-based system and the customer interest monitoring devices 150 may communicate via the Internet with the targeted offer distribution circuitry 160 using one or more gateway devices, such as one or more routers or similar.

In embodiments, the targeted offer distribution circuitry 160 may be communicably coupled to one or more data stores, data structures, or databases that include customer demographic information. In such embodiments, the targeted offer distribution circuitry 160 may identify a customer 102 using a technique such as facial recognition or using one or more devices 170 (e.g., smartphone) or products (e.g., shopper's card) carried and/or possessed by the customer 102. In such embodiments, the targeted offer distribution circuitry 160 may access information such as prior purchases made by the customer 102 prior to generating the targeted offer or directed advertising for the customer 102. Such a system beneficially increases the likelihood that the targeted offer distribution circuitry 160 will provide the customer 102 with a personally relevant offer or advertising based, at least in part, on the customer's prior purchases. In other embodiments, the targeted offer distribution circuitry 160 may access customer demographic information obtained either using the regional monitoring system 120 and/or the customer interest monitoring device 150 or by retrieving the information from one or more data stores, data structures, or databases. The demographic information may then be used by the targeted offer distribution circuitry 160 to generate relevant targeted offers or directed advertising using some or all of the customer demographic information. Such a system beneficially increases the likelihood that the targeted offer distribution circuitry 160 will provide the customer 102 with a personally relevant offer or advertising based, at least in part, on the customer's demographics (sex, age, income, etc.).

In embodiments, the targeted offer distribution circuitry 160 may acquire environmental or other ambient condition or current event information and/or data from external sources. Such information may include temperature, humidity, precipitation, sporting events, entertainment, political events, social events, and similar. The targeted offer distribution circuitry 160 may provide targeted offers and directed advertising to the customer 102 based, at least in part, on the externally sourced information and/or data. For example, if the targeted offer distribution circuitry 160 receives information that the rain is forecasted, the targeted offer distribution circuitry 160 may generate a targeted offer involving rainwear or umbrellas. In another example, if the targeted offer distribution circuitry 160 receives information that a major sporting event will occur, the targeted offer distribution circuitry 160 may generate directed advertising featuring team apparel for the teams participating in the event.

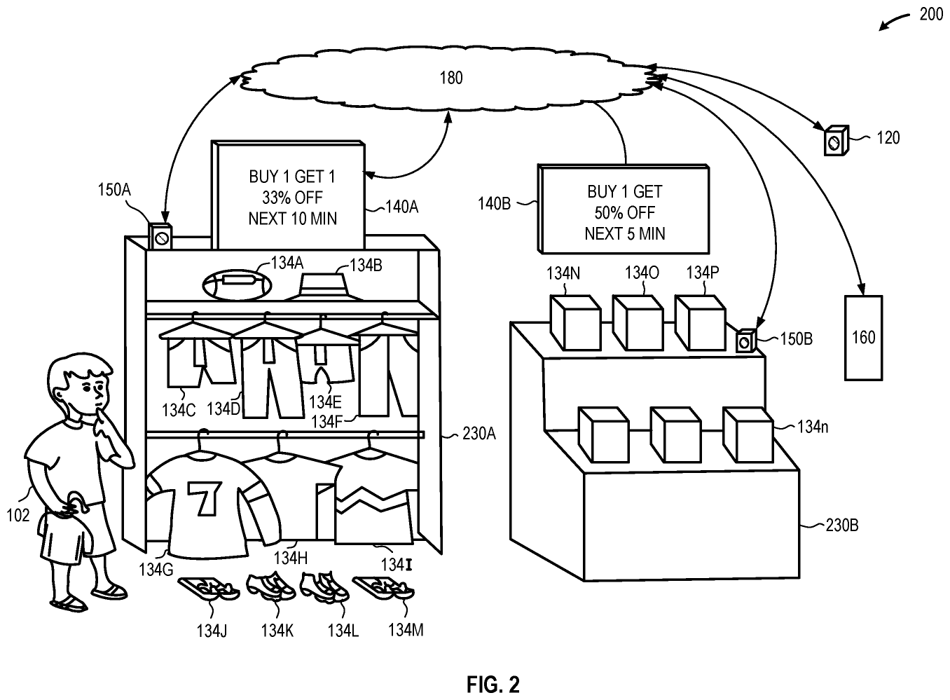

FIG. 2 is a perspective view of an illustrative automated targeted offer delivery system 200 in an example retail setting that includes a first display 230A having a first output device 140A, a second display 230B having a second output device 140B, a regional monitoring system 120, a plurality of customer interest monitoring devices 150A and 150B and targeted offer distribution circuitry 160, in accordance with at least one embodiment described herein.

The first display 230A includes at least one customer interest monitoring device 150A that generates an output signal including information and/or data used by the targeted offer distribution circuitry 160 to detect customer interest in one or more products displayed in, on, or about the first display 230A. Similarly, the second display 230B includes at least one customer interest monitoring device 150B that generates an output signal including information and/or data used by the targeted offer distribution circuitry 160 to detect customer interest in one or more products displayed in, on, or about the second display 230B. In some implementations, the customer interest monitoring devices 150A and 150B may generate and communicate the output signal to the targeted offer distribution circuitry 160 on a continuous, intermittent, periodic, or aperiodic basis. In some implementations, the customer interest monitoring devices 150A and 150B may generate and communicate the output signal to the targeted offer distribution circuitry 160 on a continuous, intermittent, periodic, or aperiodic event-driven basis only after the regional monitoring system 120 detects the presence of a customer 102 proximate the first display 230A and/or the second display 230B. In yet other implementations, the customer interest monitoring devices 150A and 150B may generate and communicate the output signal to the targeted offer distribution circuitry 160 on a continuous, intermittent, periodic, or aperiodic event-driven basis only after the regional monitoring system 120 provides information and/or data to the targeted offer distribution circuitry 160 indicative of an interest on the part of the customer 102 in one or more products displayed in, on, or about the first display 230A and/or the second display 230B.

In some embodiments, the regional monitoring system 120 tracks the movement of a customer 202 through the establishment. The regional monitoring system 120 communicates information and/or data representative of the movement of the customer 102 to the targeted offer distribution circuitry 160. The targeted offer distribution circuitry 160 detects the customer's interest in one or more products 236A-236n displayed in, on, or about the first display 230A and/or the customer's interest in one or more products 134N-134n displayed in, on, or about the second display 230B. The targeted offer distribution circuitry 160 may detect such customer interest based upon the time the customer 102 spends proximate the first display 230A and the second display 230B. The targeted offer distribution circuitry 160 may detect such customer interest based upon one or more biometric indicators, such as eye-tracking, movement, gestures, arm tracking, etc.

In some implementations, the customer interest monitoring devices 150A and 150B may include image acquisition devices 152A and 152B, respectively. In such implementations, the customer interest monitoring devices 150A and 150B generate and communicate to the targeted offer distribution circuitry 160 output signals containing information and/or data representative of the images acquired by the image acquisition devices 152A and 152B. The targeted offer distribution circuitry 160 detects customer interest in the products 134A-134M displayed in, on, or about the first display 230A and/or the customer's interest in one or more products 134N-134n displayed in, on, or about the second display 230B based on the content of the received images. For example, the targeted offer distribution circuitry 160 may perform one or more biometric analyses on the received images. Example biometric analyses may include, but are not limited to, facial expression, eye movement, and the like. In another example, the targeted offer distribution circuitry 160 may assess the received image information and/or data to detect interaction between the customer 102 in the products 134A-134M displayed in, on, or about the first display 230A and/or interaction between the customer 102 and one or more products 134N-134n displayed in, on, or about the second display 230B.

In some implementations, the customer interest monitoring devices 150A and 150B may include one or more transceivers capable of exciting one or more passive devices disposed in, on, or about the products 134A-134M displayed in, on, or about object display 230A and/or the one or more products 134N-134n displayed in, on, or about the second display 230B. In embodiments, the customer interest monitoring devices 150A and 150B may include one or more transceivers may include one or more radio frequency (RF) transceivers capable of receiving a signal from one or more active (e.g., self-powered) or passive (e.g., externally powered) RF devices in tags or similar devices physically coupled to products 134. For example, the customer interest monitoring devices 150A and 150B may include RFID readers and RFID tags may be disposed in, on, or about some or all of the products 134A-134M displayed in, on, or about the first display 230A and/or the one or more products 134N-134n displayed in, on, or about the second display 230B. In such implementations, the customer interest monitoring devices 150A and 150B generate and communicate to the targeted offer distribution circuitry 160 output signals containing information and/or data representative of the RFID fingerprints obtained by each of the image acquisition devices 152A and 152B. The targeted offer distribution circuitry 160 detects customer interest in the products 134A-134M displayed in, on, or about the first display 230A and/or the customer's interest in one or more products 134N-134n displayed in, on, or about the second display 230B based on changes in the RFID fingerprints received from the customer interest monitoring devices 150A and/or 150B.

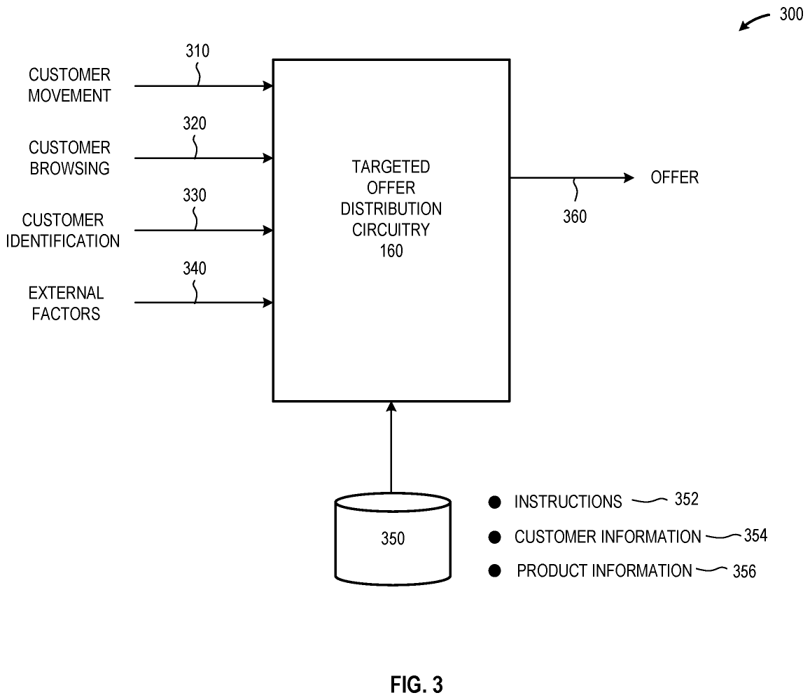

FIG. 3 is an input/output (I/O) diagram 300 of illustrative targeted offer distribution circuitry 160, in accordance with at least one embodiment described herein. The targeted offer distribution circuitry 160 may include any number and/or combination of electrical components, semiconductor devices, and/or logic elements capable of generating a target offer or directed advertising based upon detected customer interest in at least one object.

In embodiments, each of the regional monitoring systems 120 generates an output signal 310 that includes information and/or data representative of a location and/or movement of a customer 102 within an establishment 110. The targeted offer distribution circuitry 160 receives the output signal generated by each of the regional monitoring systems 120. In embodiments, the targeted offer distribution circuitry 160 may use all or a portion of the information and/or data included in the output signals 310 received from some or all of the regional monitoring systems 120 to detect an interaction between a customer 102 and one or more products 134 based, at least in part, on the location, movement, and/or lingering of the customer 102 in the establishment 110. For example, a customer 102 who lingers or remains proximate a display 130 for greater than a defined temporal threshold (e.g., more than 15 seconds; more than 30 seconds; more than 60 seconds; more than 90 seconds) may be indicative of an interaction between the customer 102 and one or more displayed products 134.

In embodiments, each of the customer interest monitoring devices 150 generates an output signal that includes information and/or data representative of an interaction between a customer 102 and one or more products 134. Such an interaction may depend upon the nature of the product 134. For example, an interaction between a customer 102 and a product 134 such as a fruit may include the customer 102 feeling the firmness of the fruit or smelling the fruit. In another example, interaction between a customer 102 and a product 134 such as clothing may include the customer removing clothing from the rack and viewing the front and rear of the clothes. In another example, an interaction between a customer 102 and a product 134 such as a music compact disc may include the customer examining the track listing on the back cover of the jewel case containing the compact disc.

In some embodiments, the customer interest monitoring device 150 may include an image acquisition device such as a still or video camera that generates an output signal 320 containing information and/or data representative of one or more acquired images. In some embodiments the customer interest monitoring device 150 may include a radio frequency (RF) device, such as an RF transmitter, receiver, or transceiver capable of receiving signals provided by an active or passive RF device attached to the products 134 and generating an output signal 320 that includes information and/or data representative of one or more products 134. In embodiments, the RF device may include a radio frequency identification (RFID) reader that generates an output signal 320 containing information and/or data representative of an RFID fingerprint obtained by the customer interest monitoring device 150. The targeted offer distribution circuitry 160 receives the output signal 320 generated by each of the customer interest monitoring devices 150. In embodiments, the targeted offer distribution circuitry 160 may use all or a portion of the information and/or data included in the output signals 320 received from some or all of the customer interest monitoring devices 150 to detect a customer's interest in one or more products based, at least in part, on the observed or detected customer interaction with the object.

In embodiments, the targeted offer distribution circuitry 160 may receive information and/or data that uniquely identifies a customer 102. Such may include information and/or data representative of prior purchases made by the customer 102. Such may include information and/or data representative of one or more demographics logically associated with the customer 102. The targeted offer distribution circuitry 160 may receive such prior purchase and/or demographic information by causing one or more systems to scan a shopper card or similar uniquely assigned customer identifier. The targeted offer distribution circuitry 160 may receive such demographic information by communicating with one or more processor based devices 170 carried by the customer. Such information may be obtained from any source, for example from an enterprise business system used to uniquely identify customers within an establishment 110.

In some implementations, the targeted offer distribution circuitry 160 may be communicably coupled to one or more local or remote storage devices 350 that include one or more data stores, data structures, or databases that include customer prior purchase and/or demographic information. The targeted offer distribution circuitry 160 receives one or more signals 330 containing information and/or data representative of unique customer identifiers. Using the unique customer identifier information and/or data, the targeted offer distribution circuitry 160 may retrieve from one or more storage devices 350 prior purchase and/or demographic information associated with the customer. The targeted offer distribution circuitry 160 my generate targeted offers and/or directed advertising based, at least in part, on the item of interest to the customer 102, the customer's prior purchases, and/or the customer's demographics.

In embodiments, the targeted offer distribution circuitry 160 may receive one or more signals 340 that include information and/or data representative of one or more external factors, such as information and/or data representative of environmental conditions, local events, news events, etc. For example, such environmental conditions may include, but are not limited to, temperature, weather, precipitation, local sporting events, local entertainment events, and similar. The targeted offer distribution circuitry 160 my generate targeted offers and/or directed advertising based, at least in part, on the item of interest to the customer and one or more environmental conditions.

The targeted offer distribution circuitry 160 may be communicably coupled to one or more local or remote storage devices 350. Such storage devices 350 may include one or more data stores, data structures, and/or databases containing information and/or data associated with customer prior purchase and demographic information. Such storage devices 350 may include one or more data stores, data structures, and/or databases containing information and/or data associated with products or products displayed or offered for sale within the establishment. Such product information may include, but is not limited to, information and/or data associated with product pricing, manufacturer suggested retail pricing, wholesale pricing, allowable discounts, and similar information useful to the targeted offer distribution circuitry 160 in determining an appropriate discount for a targeted offer and/or a directed advertisement. The one or more storage devices 350 may additionally include one or more machine-executable instruction sets used by the targeted offer distribution circuitry 160 to analyze the information and/or data received in some or all of the customer location tracking signal 310; the customer interest signal 320; the customer identification signal 330; and the external factors signal 340. The one or more storage devices 350 may additionally include one or more machine-executable instruction sets used to generate the targeted offers and directed advertising using the received customer interest information, the received customer identification information, and the received object or product information.

The targeted offer distribution circuitry 160 generates an output signal 360 that includes information and/or data representative of a human perceptible output for presentation to the customer via one or more output devices 140 and/or via one or more devices 170 carried or possessed by the customer 102.

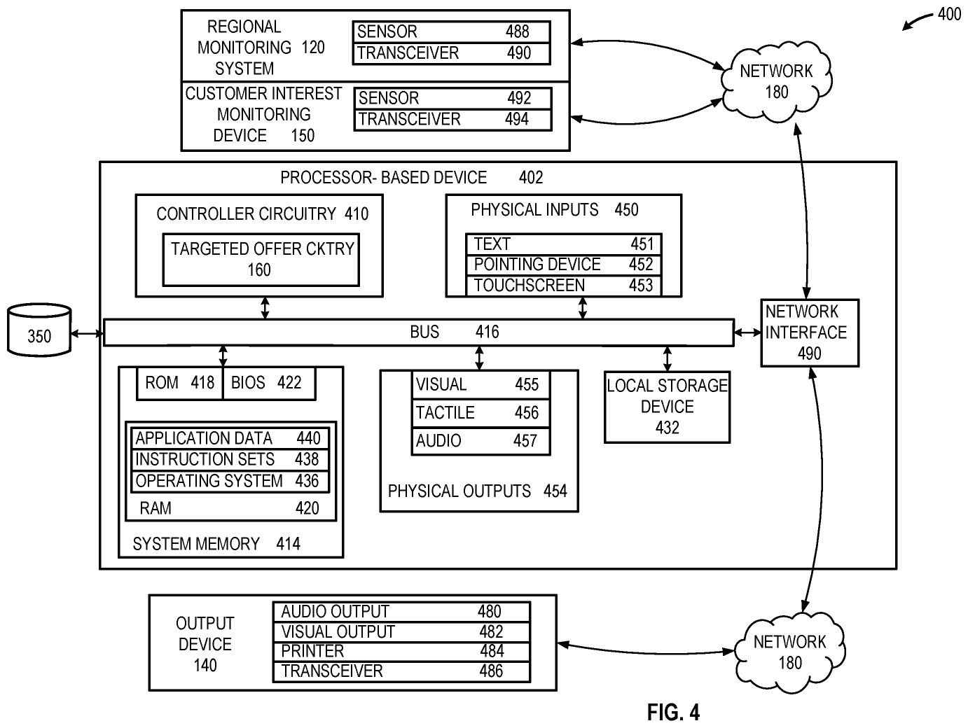

FIG. 4 is a block diagram of an illustrative targeted offer distribution system 400 that includes a regional monitoring system 120, a customer interest monitoring device 150, and an output device 140 communicably coupled to a processor-based device 402 via a network 180, in accordance with at least one embodiment described herein. The following discussion provides a brief, general description of the components included in an illustrative targeted offer distribution system 400 that includes a regional monitoring system 120, a customer interest monitoring device 150, and an output device 140 communicably coupled to a processor-based device 402 that includes targeted offer distribution circuitry 160 and in which the various illustrated embodiments can be implemented.

Although not required, some of the embodiments may be described in the general context of machine-readable or computer-executable instruction sets, such as program application modules, objects, or macros being executed by the controller circuitry 410 to provide the targeted offer distribution circuitry functionality described herein. Those skilled in the relevant arts will appreciate that the illustrated embodiments as well as other embodiments can be practiced with other processor or controller-based devices that may include, but are not limited to: portable electronic or handheld electronic devices, as exemplified by smartphones, portable computers, wearable computers, microprocessor-based or programmable customer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The processor-based device 402 may include or be formed using any number of circuits, some or all of which may include numbers and combinations of hard-wired and/or configurable electronic components, semiconductor devices, and/or logic elements that are disposed partially or wholly in a PC, server, or other computing system capable of executing machine-readable instructions. The processor-based device 402 may include controller circuitry 410, and may, at times, include a bus structure or communications link 416 communicably coupling various system components including a system memory 414 to the controller circuitry 410 and/or the targeted offer distribution circuitry 160. The processor-based device 402 may, at times, be referred to in the singular herein, but this is not intended to limit the embodiments to a single system, since in certain embodiments, there will be more than processor-based device 402 that may incorporate any number of collocated or remote networked circuits or devices.

The controller circuitry 410 may include any number, type, or combination of devices. At times, the controller circuitry 410 may be implemented in whole or in part in the form of semiconductor devices such as diodes, transistors, inductors, capacitors, and resistors. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), field programmable gate arrays (FPGAs), and the like. Unless described otherwise, the construction and operation of the various blocks shown in FIG. 4 are of conventional design. As a result, such blocks need not be described in further detail herein, as they will be understood by those skilled in the relevant art. The bus structure 416 that interconnects at least some of the components of the processor-based device 402 may employ any known serial or parallel bus structure or architecture.

The system memory 414 may include read-only memory (“ROM”) 418 and random access memory (“RAM”) 420. A portion of the ROM 418 may contain a basic input/output system (“BIOS”) 422. The BIOS 422 may provide basic functionality to the processor-based device 402, for example by causing the controller circuitry 410 to load one or more machine-readable instruction sets that cause at least a portion of the controller circuitry 410 to transform, transition, provide, or otherwise function as a dedicated, specific, and particular machine, such as the targeted offer distribution circuitry 160.

A portion of the RAM 420 may include an operating system 436 for the processor-based device 402, various machine readable instruction sets 438, and application data 440 associated with applications executed by the controller circuitry 410. The RAM 420 may have any capacity (2 gigabytes (GB), 4 GB, 8 GB, 16 GB, 32 GB, etc.). The RAM may include any type and/or configuration of data storage devices including, but not limited to, dynamic random access memory (DRAM), static random access memory (SRAM), and similar. In some implementations, a portion of RAM 920 may be used to implement one or more virtual devices, such as one or more virtual machines.

The processor-based device 402 may include one or more communicably coupled, non-transitory, local data storage devices 432. The one or more local data storage devices 432 may include any current or future developed non-transitory storage devices. Non-limiting examples of such local data storage devices 432 may include, but are not limited to any current or future developed nontransitory storage appliances or devices, such as one or more magnetic storage devices, one or more optical storage devices, one or more solid-state electromagnetic storage devices, one or more electroresistive storage devices, one or more molecular storage devices, one or more quantum storage devices, or various combinations thereof. In some implementations, the one or more local data storage devices 432 may include one or more removable storage devices, such as one or more flash drives or similar appliances or devices.

The local one or more storage devices 432 may include interfaces or controllers (not shown) communicatively coupling the respective storage device or system to the bus structure 416, as is known by those skilled in the art. The one or more local storage devices 432 may contain machine-readable instruction sets, data structures, program modules, data stores, databases, logical structures, and/or other data useful to the controller circuitry 410 and/or the targeted offer distribution circuitry 160.

One or more external storage devices 350 may be communicably coupled to the processor-based device 402. In some implementations, the one or more external storage devices 350 may be disposed local to or remote from the processor-based device 402. In embodiments, the one or more external storage devices 350 may be a network connected storage device. For example, the one or more external storage devices 350 may include one or more Internet connected, cloud-based, file servers. The one or more external storage devices 350 may include, but are not limited to, memory sticks, memory cards, hard disk drives, solid state drives, network connected storage (e.g., “cloud storage”), or combinations thereof.

Machine-readable instruction sets 438 and other modules 440 may be stored in whole or in part in the system memory 414. Such instruction sets 438 may be transferred from one or more storage devices 432 and/or one or more external storage devices 350 and stored in the system memory 414 in whole or in part when executed by the configurable circuitry 410. For example, one or more machine-readable instruction sets 438 may cause the configurable circuitry 410 to form, generate, create, assemble, or otherwise provide the targeted offer distribution circuitry 160. One or more machine-readable instruction sets 438 may cause the targeted offer distribution circuitry 160 to analyze information and/or data received from one or more regional monitoring systems 120 to detect and/or track movement of customers 102 in the establishment 110. One or more machine-readable instruction sets 438 may cause the targeted offer distribution circuitry 160 to analyze information and/or data received from one or more regional monitoring systems 120 to uniquely identify at least some of the customers 102 in the establishment 110. Such unique identification may include one or more biometric recognition techniques (e.g., facial recognition), reading one or more unique identifiers from media or a device possessed by the customer 102 (e.g., device MAC address, RFID shopper card, mag-stripe shopped card), or combinations thereof. One or more machine-readable instruction sets 438 may cause the targeted offer distribution circuitry 160 to detect customer interest in one or more items or products in the establishment 110 based at least on the customer's movements within the establishment 110. One or more machine-readable instruction sets 438 may cause the targeted offer distribution circuitry 160 to detect customer interest in one or more items or products in the establishment 110 based, at least in part, on a prior purchase history logically associated with the customer and/or demographics logically associated with the customer. Such prior purchase history and/or demographics information may be stored or otherwise retained in one or more data stores, data structures, or databases that retained or otherwise disposed in, on, or about local data storage 932 and/or the one or more external storage devices 350.

One or more machine-readable instruction sets 438 may cause the targeted offer distribution circuitry 160 to analyze information and/or data received from one or more customer interest monitoring devices 150 to detect customer interest in one or more items or products in the establishment 110 based, at least in part, on customer interaction with the one or more items or products (touching, holding, smelling, tasting, etc.). One or more machine-readable instruction sets 438 may cause the targeted offer distribution circuitry 160 to generate one or more targeted offers or directed advertisements for communication to an output device proximate or carried by the customer 102. Such targeted offers or directed advertisements may include a temporal limitation on their use (offer expires in 3 minutes; 5 minutes; 10 minutes, etc.). The addition of a temporal limitation to the offer or advertisement beneficially increases the likelihood of a near-term sale of the item or object to the customer and reduces the opportunity for the customer to comparison shop either in online marketplaces or in other brick-and-mortar establishments. The targeted offer distribution circuitry 160 may generate the targeted offers or directed advertisements based on the customer interaction with the item/object or a related item/object. The targeted offer distribution circuitry 160 may generate the targeted offers or directed advertisements based, at least in part, on the prior purchase history logically associated with the customer 102 and/or the demographics of the customer 102.

System users provide, enter, or otherwise supply commands (e.g., acknowledgements, selections, confirmations, and similar) as well as information (e.g., subject identification information, color parameters) to the processor-based device 402 using one or more communicably coupled physical input devices 450 such as one or more text entry devices 451 (e.g., “hard” or “soft” keyboards), one or more pointing devices 452 (e.g., mouse, trackball, touchscreen), and/or one or more audio input devices 453. Some or all of the physical input devices 450 may be wired or wirelessly communicably coupled to the processor-based device 402.

System users receive output from the processor-based device 402 via any number of physical output devices 454. Example physical output devices 454 may include, but are not limited to, any current or future developed display devices 455; tactile output devices 456; audio output devices 457, or combinations thereof. Some or all of the physical input devices 450 and some or all of the physical output devices 454 may be communicably coupled to the processor-based device 402 via one or more tethered interfaces, hardwire interfaces, or wireless interfaces, for example a wireless device communicably coupled to the processor-based device 402 via the network 180.

For convenience, the network interface 490, the controller circuitry 410, the system memory 414, the physical input devices 450 and the physical output devices 454 are illustrated as communicatively coupled to each other via the bus structure 416, thereby providing connectivity between the above-described components. In alternative embodiments, the above-described components may be communicatively coupled in a different manner than illustrated in FIG. 4. For example, one or more of the above-described components may be directly coupled to other components, or may be coupled to each other, via one or more intermediary components (not shown). In some embodiments, all or a portion of the bus structure 416 may be omitted and the components are coupled directly to each other using suitable tethered, hardwired, or wireless connections.

Each of the regional monitoring systems 120 includes at least one sensor 488 and at least one transceiver 490. The at least one sensor 488 may include any number and/or combination of sensors capable of detecting the presence and/or movement of customers through an establishment. In embodiments, the at least one sensor 488 may include, but is not limited to, a visible image acquisition device; a near-infrared image acquisition device; a radio frequency identification (RFID) reader or interrogator; radio frequency (RF) signal detector; or combinations thereof. The at least one sensor 488 generates one or more output signals that contain information and/or data representative of the data acquired by the respective sensor. The at least one transceiver 490 communicates the output signal to the processor-based device 402 and to the targeted offer distribution circuitry 160.

Each of the customer interest monitoring devices 150 includes at least one sensor 492 and at least one transceiver 494. The at least one sensor 492 may include any number and/or combination of sensors capable of detecting an interaction between a customer 102 and one or more items or products within an establishment 110. In embodiments, the at least one sensor 492 may include, but is not limited to, a visible image acquisition device; a near-infrared image acquisition device; a radio frequency identification (RFID) reader or interrogator; or combinations thereof. The at least one sensor 492 generates one or more output signals that contain information and/or data representative of the data acquired by the respective sensor. The at least one transceiver 494 communicates the output signal to the processor-based device 402 and to the targeted offer distribution circuitry 160.

The output device 140 communicably couples to the processor-based device 402 and to the targeted offer distribution circuitry 160 via transceiver 486 and the one or more networks 180. The output device 140 receives at least one signal containing information and/or data representative of the targeted offer or directed advertising generated by the targeted offer distribution circuitry 160. In implementations, the output device 140 may include one or more audio output devices 480, such as one or more speakers or similar devices. In implementations, the output device 140 may include one or more visual output devices 482, such as a display device or digital signage. In implementations, the output device 140 may include one or more printers or similar hardcopy producing devices. For example, the output device 140 may include a coupon printer or similar device. The output device 140 may include one or more fixed or moveable output devices disposed in establishment 110. In embodiments, the output device may be carried or possessed by the customer 102. For example, the output device may include a smartphone or similar processor-based device having audio and/or visual output capabilities.

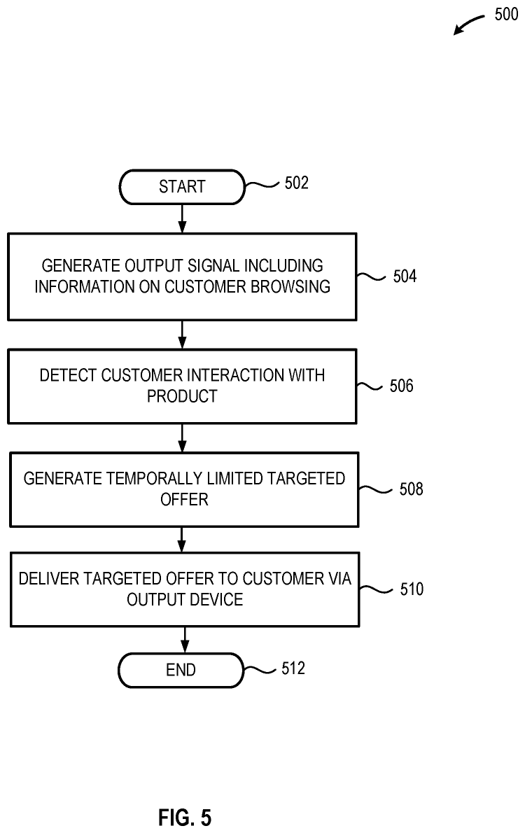

FIG. 5 is a high-level logic flow diagram of an illustrative targeted offer distribution method 500, in accordance with at least one embodiment described herein. In embodiments, upon detecting customer interest in one or more items or products, the targeted offer distribution circuitry 160 generates and communicates a targeted offer or directed advertising to an output device 140 proximate the customer 102. The targeted offer or directed advertising provides a promotional offer to the customer 102 based on the object or item of interest and may also provide promotional offers based on the customer's prior purchases and/or the customer's demographics. The promotional offer included in the targeted offer or directed advertising is available to the customer 102 for only a limited duration to encourage the customer 102 to complete the purchase without searching online marketplaces or competitor brick-and-mortar establishments. The method 500 commences at 502.

At 504, one or more customer interest monitoring devices 150 generate an output signal including information on customer browsing or interaction with one or more products 134 in the establishment 110. In embodiments, the output signal 320 may include information and/or data representative of a still or video image. In embodiments, the output signal 320 may include information and/or data representative of a radio frequency identification (RFID) fingerprint. The one or more customer interest monitoring devices 150 communicates the output signal to the targeted offer distribution circuitry 160.

At 506, customer interest in one or more products 134 may be detected based upon the observed interaction between the customer 102 and the one or more products 134. In embodiments, the targeted offer distribution circuitry 160 analyzes the information and/or data provided by one or more customer interest monitoring devices 150 to detect customer interest in the one or more products 134. In other embodiments, the targeted offer distribution circuitry 160 may be distributed among the customer interest monitoring devices 150. In such instances, some or all of the customer interest monitoring devices 150 may detect customer interest in the one or more products 134. Customer interest in one or more products 134 may be detected based upon the actions of the customer 102 when proximate the one or more products 134. For example, the customer interest monitoring device 150 or the targeted offer distribution circuitry 160 may consider a customer 102 who pauses or lingers proximate a product display 130 containing one or more products 134 as interested in the one or more products. In another example, the customer interest monitoring device 150 and/or the targeted offer distribution circuitry 160 may consider a customer 102 who interacts with one or more products 134 as interest in the one or more products 134.

At 508, the targeted offer distribution circuitry 160 generates a targeted offer or directed advertisement based at least on the detected customer interest in the one or more products 134. In embodiments, the targeted offer or directed advertisement may include a promotional offer on the same or similar items or products (e.g., buy one, get one 50% off). In embodiments, the targeted offer or directed advertisement may include a promotional offer on different, but related items (e.g., buy an oil filter, get 25% off 5 quarts of oil). In some implementations, the targeted offer distribution circuitry 160 may generate the targeted offer or directed advertisement based, at least in part, on information and/or data indicative of one or more prior product purchases by the customer. In some implementations, the targeted offer distribution circuitry 160 may generate the targeted offer or directed advertisement based, at least in part, on information and/or data indicative of product purchases made by prior customers who purchased the one or more products of interest to the current customer 102. In some implementations, the targeted offer distribution circuitry 160 may generate the targeted offer or directed advertisement based, at least in part, on demographic information and/or data logically associated with the customer 102. In some implementations, the targeted offer distribution circuitry 160 may generate the targeted offer or directed advertisement based, at least in part, on demographic information and/or data logically associated with prior customers who purchased the one or more products of interest to the current customer 102.

At 510, the targeted offer distribution circuitry 160 communicates the targeted offer or directed advertisement to an output device. In some implementations, the output device 140 may include an audio or visual output device positioned proximate the customer 102. In some implementations, the output device 140 may include a hardcopy output device, such as a coupon printer or similar positioned or otherwise disposed proximate the customer 102. In some implementations, the output device may include one or processor-based devices, such as a smartphone, carried or possessed by the customer 102. The method 500 concludes at 512.

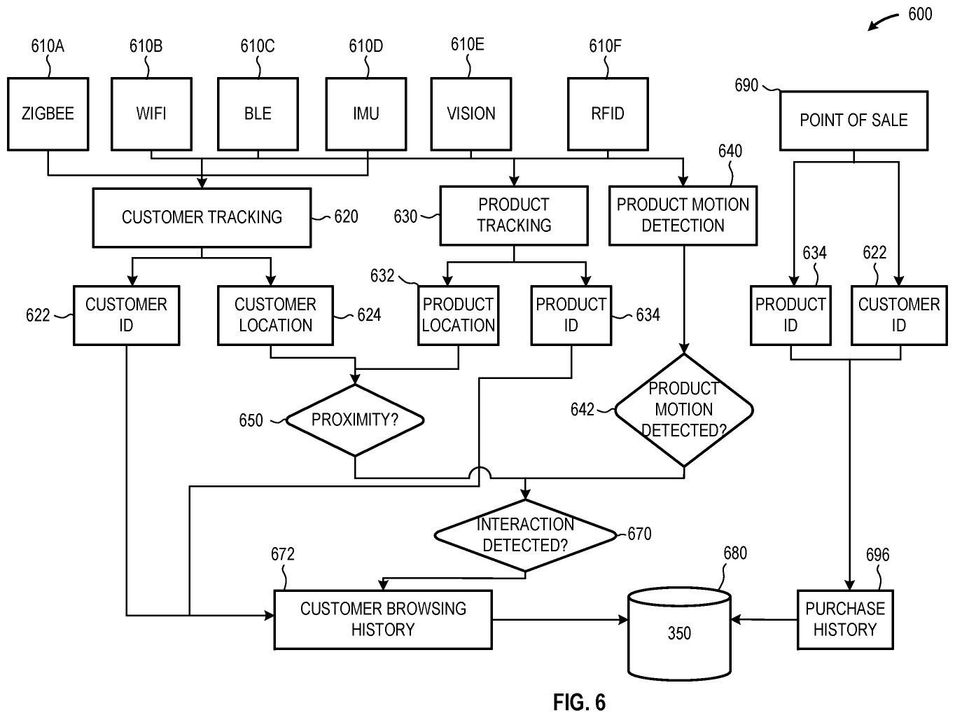

FIG. 6 is a system-level flow diagram of an illustrative customer/product interaction tracking system 600, in accordance with at least one embodiment described herein. The method 600 may be used alone or in conjunction with the method 500 described in detail with regard to FIG. 5. As depicted in FIG. 6, in embodiments, a sensor fusion process may be employed in which a number of modalities track the movement of customers in an establishment, the movement of products in the establishment, and the interaction between the customers and the products based on the tracked movement of each.

Customer/product interaction tracking uses information and/or data obtained from a variety of devices 610A-610n (collectively “devices 610”) that are assimilated to provide customer tracking information and/or data 620, product tracking information and/or data 630, and product motion information and/or data 640. The devices 610 may include any number and/or combination of transmitters, receivers, transceivers, and/or sensors capable of identifying customers 622, determining a customer's location in an establishment 624, determining a product's location in an establishment 632, identifying a product 634, detecting the movement of a product in the establishment 642 and determining whether a customer 102 and a product 134 are proximate 650. The devices 610 may include any number and/or combination of Zigbee® compatible sensors 610A, IEEE 802.11 (Wi-Fi) compatible transceivers 610B, Bluetooth®/Bluetooth Low Energy® compatible sensors 610C, inertial measurement unit (IMU) sensors 610D, still and/or video image acquisition devices or sensors 610E, and/or radio frequency identification (RFID) interrogators, detectors, self-powered RFID tags, and/or externally powered RFID tags 610F.

In embodiments, the targeted offer distribution circuitry 160 uses information and/or data received from the devices 610 to determine whether a customer 102 is proximate 650 one or more products 134. The targeted offer distribution circuitry 160 then determines whether the product 134 is moving 642. If the targeted offer distribution circuitry 160 determines the customer 102 and the product 134 are proximate and the product 134 is in motion, the targeted offer distribution circuitry 160 has detected customer 102 interaction with the product 670.

In some implementations, the targeted offer distribution circuitry 160 may use the received customer identification information 622 and the received product identification information 634 to generate a browsing history 672 that may be logically associated with the customer 102. The browsing history 672 may be stored in one or more data stores, data structures, or databases stored, disposed, or otherwise retained on the storage device 350.

The customer/product interaction tracking system 600 may additionally include a point of sale (POS) customer purchase history tracking system 690. The POS tracking system 690 maintains one or more data stores, data structures, or databases that include information and/or data indicative of the products 134 purchased by a customer 102. In some implementations, the products purchased by the customer 102 may each have a logically associated product identifier 634. Similarly, each customer 102 may have a logically associated customer identifier 622. In embodiments, the POS tracking system 690 may maintain one or more purchase history data stores, data structures, or databases in which a customer identifier 622 is logically associated with any number of product identifiers 634, each associated with a product 134 purchased by the respective customer 102. The POS tracking system 690 may store, dispose, or otherwise retain the one or more purchase history data stores, data structures, or databases containing customer identifiers 622 and logically associated product identifiers 634 on the storage device 350.

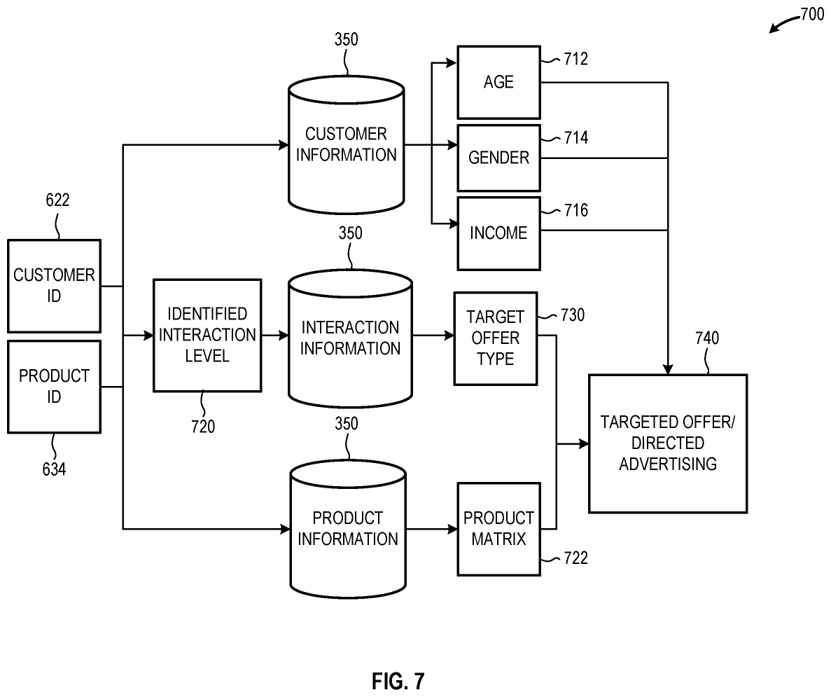

FIG. 7 is a system-level flow diagram of an illustrative product pricing system 700 in which the targeted offer distribution circuitry 160 uses customer information, product information, and the customer's interaction with a product 134 to determine a personalized targeted offer or directed advertisement for the product 134, in accordance with at least one embodiment described herein. The method 700 may be used alone or in conjunction with the method 500 described in detail with regard to FIG. 5 and/or the system 600 described in detail with regard to FIG. 6. As depicted in FIG. 7, in embodiments, the targeted offer distribution circuitry 160 may use multiple data stores, data structures, or databases to generate a personalized targeted offer or directed advertisement for a customer.

In embodiments, the targeted offer distribution circuitry 160 may detect and identify a customer 102 present in the establishment 110, for example using one or more regional monitoring systems 120. The targeted offer distribution circuitry 160 may retrieve, look-up, or otherwise determine a customer identifier 622 logically associated with the identified customer 102. The targeted offer distribution circuitry 160 may identify customer/product interaction between the identified customer 102 and a product 134 using one or more customer interest monitoring devices 150. Upon detecting customer interaction with the product 134, the targeted offer distribution circuitry 160 may retrieve, look-up, or otherwise determine a product identifier 634 logically associated the product 134 of interest to the customer 102.

The targeted offer distribution circuitry 160 may also assess the interaction between the customer 102 and the product 134 to identify an interaction level 720 between the customer 102 and the product 134. Such interaction levels may be based on one or more interaction factors. Example interaction factors may include, but are not limited to: the amount of time the customer spends with the product 134; whether the customer 102 handles the product 134; whether the customer smells the product 134; whether the customer 102 tastes the product 134; whether the customer 102 reads labels or tags associated with the product 134; and combinations thereof. Based on the determined level of interaction between the customer 102 and the product 134, the targeted offer distribution circuitry 160 may retrieve, look-up, or otherwise obtain interaction information from an interaction data store, data structure, or database. The interaction data store, data structure, or database may be stored, disposed, or otherwise retained in, on, or about the storage device 350. Based on the level of interaction and the information and/or data obtained from the interaction data store, data structure, or database, the targeted offer distribution circuitry 160 determines the type of targeted offer or directed advertisement 730 to provide to the customer 102. The type of targeted offer 730 may include, but is not limited to: a temporally limited percentage discount on the product 134 of interest to the customer 102 (e.g., “Buy within the next 5 minutes and take 25% off.”); a percentage discount on additional identical products of interest to the customer 102 (e.g., “Buy the 1^{st} within the next 5 minutes and get the second for 25% off.”); a percentage discount on additional related products of interest to the customer 102 (e.g., “Buy the oil filter within the next 5 minutes and get 25% off up to 7 quarts of motor oil.”); and similar.

Based on the customer identifier 622, the targeted offer distribution circuitry 160 may obtain customer demographic information from a customer information data store, data structure, or database. In embodiments, the customer information data store, data structure, or database may be stored, disposed, or otherwise retained in, on, or about the storage device 350. The demographic information obtained by the targeted offer distribution circuitry 160 may include, but is not limited to: the customer's age 712; the customer's gender 714; and/or the customer's income level 716. The demographic information may be used by the targeted offer distribution circuitry 160 to select appropriate content for the targeted offer or directed advertisement. For example, the targeted offer distribution circuitry 160 may select appropriate promotional offers and/or products based on the customer's age (e.g., products 134 useful for seniors would not typically be included in a targeted offer presented to a teenager); the customer's gender (e.g., products for men would not typically be included in a targeted offer presented to a woman); and/or the customer's income level (e.g., products offered would be considered appropriate for the customer's income level).

Based on the product identifier 634, the targeted offer distribution circuitry 160 may obtain product information from a product information data store, data structure, or database. In embodiments, the product information data store, data structure, or database may be stored, disposed, or otherwise retained in, on, or about the storage device 350. The product information obtained by the targeted offer distribution circuitry 160 may include a product matrix 722 that provides appropriate discounts, related products and similar information for some or all of the products 134 offered by the establishment 110.

Using the customer demographic information 712, 714, 716, the targeted offer type selection 730, and the product matrix 722, the targeted offer distribution circuitry 160 generates a personalized targeted offer or directed advertisement 740.

While FIGS. 5, 6, and 7 illustrate various operations according to one or more embodiments, it is to be understood that not all of the operations depicted in FIGS. 5, 6, and 7 are necessary for other embodiments. Indeed, it is fully contemplated herein that in other embodiments of the present disclosure, the operations depicted in FIGS. 5, 6, and 7, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), rewritable compact disks (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to systems and methods for autonomously generating temporally limited targeted offers and/or directed advertisements based on detected interaction between customers and products. A regional monitoring system may detect the movement of a customer in the establishment. A customer that moves within a limited area of the establishment may be identified by targeted offer distribution circuitry as interested in one or more products in the area. A customer interest monitoring device detects interaction between the customer and the product. The customer interest monitoring device may include an image capture device or an RFID interrogator, both of which are capable of detecting the interaction between the customer and the product. Using information obtained from the customer interest monitoring device, the targeted offer distribution circuitry autonomously generates a temporally limited targeted offer or directed advertisement. The targeted offer distribution circuitry delivers the targeted offer or directed advertisement to an output device proximate the customer or to a processor-based device or media carried or possessed by the customer.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for autonomously generating and delivering a temporally limited targeted offer to a customer based on detected interaction between the customer and one or more products in an establishment.

According to example 1, there is provided a targeted offer distribution system. The system may include: a customer interest monitoring device to generate an output signal that includes information indicative of customer browsing of products in a retail environment; an output device; controller circuitry communicably coupled to the customer interest monitoring device and to the display device; and a storage device containing machine-executable instructions, that when executed by the controller circuitry, transform the controller circuitry to targeted offer distribution circuitry, the targeted offer distribution circuitry to: detect customer interaction with one or more products using the information included in the customer interest monitoring device output signal; generate a temporally limited targeted offer based at least in part on the detected customer interaction with the one or more products; and deliver the temporally limited targeted offer to the output device.

Example 2 may include elements of example 1 where the customer interest monitoring device may include an image acquisition device and the output signal may include data representative of one or more images obtained by the image acquisition device.

Example 3 may include elements of example 1 where the customer interest monitoring device includes a radio frequency (RF) device; where each of the one or more products includes a respective RF emitter coupled to the respective product, each RF emitter to output an RF signal that includes at least data representative of a unique identifier logically associated with a respective one of the plurality of products; where the output signal produced by the RF device includes data representative of one or more of: the unique identifier associated with a respective one of the plurality of products; a strength of an RF signal received from the RF emitter coupled to the respective one or the plurality of products; or a phase of the RF signal received from an RF emitter coupled to the respective one or the plurality of products; and where the machine-executable instructions further cause the targeted offer distribution circuitry to: detect one or more changes in the received RF signal, the one or more changes in the received RF signal attributable to customer interaction with the one or more products.

Example 4 may include elements of example 1, and the system may additionally include a regional monitoring system communicably coupled to the controller circuitry, the regional monitoring system to generate an output signal indicative of at least one of: a customer's movement or a customer's location within one or more portions of the retail environment, where the machine-executable instructions further cause the targeted offer distribution circuitry to cause the customer interest monitoring device to generate the output signal responsive to a determination that the customer has remained in a defined area of the retail environment for a time that exceeds a defined temporal threshold.

Example 5 may include elements of example 1 where the output device may include digital signage proximate the one or more products.

Example 6 may include elements of example 1 where the output device may include a coupon dispenser proximate the one or more products.

Example 7 may include elements of example 1 where the output device may include a processor-based device possessed by the customer.

Example 8 may include elements of example 1, and the system may additionally include a customer identification device to uniquely identify the customer in the retail establishment and retrieve demographic information about the customer; where the customer identification device retrieves the demographic information associated with the customer responsive to uniquely identifying the customer; and where the machine-executable instructions that cause the targeted offer distribution circuitry to deliver a temporally limited offer based on the detected customer interaction with the one or more products further cause the targeted offer distribution circuitry to: deliver a temporally limited offer based on the detected customer interaction with the one or more products and based on the retrieved demographic information.

Example 9 may include elements of example 8 where the customer identification device uniquely identifies the customer using a radio frequency identification (RFID) tag embedded in an product possessed by the customer.

Example 10 may include elements of example 8 where the customer identification device uniquely identifies the customer using a processor-based handheld device possessed by the customer.

According to example 11, there is provided a targeted offer distribution method. The method may include: generating an output signal that includes information indicative of customer browsing of products in a retail environment by a customer interest monitoring device; detecting customer interaction with one or more products using the information included in the customer interest monitoring device output signal by targeted offer distribution circuitry communicably coupled to the customer interest monitoring device; generating, by the targeted offer distribution circuitry, a temporally limited offer directed to at least one product based on the detected customer interaction with the one or more products; and delivering the temporally limited offer via an output device communicably coupled to the targeted offer distribution circuitry.

Example 12 may include elements of example 11 where generating an output signal that includes information indicative of customer browsing of products in a retail environment by a customer interest monitoring device may include: generating an output signal that includes information indicative of customer browsing of products in a retail environment by a customer interest monitoring device that includes an image acquisition device; where the output signal includes data representative of one or more images obtained by the image acquisition device.

Example 13 may include elements of example 11 where generating an output signal that includes information indicative of customer browsing of products in a retail environment by a customer interest monitoring device may include: generating an output signal that includes information indicative of customer browsing of products in a retail environment by a customer interest monitoring device that includes a radio frequency (RF) device; where each of the one or more products includes a respective RF emitter coupled to the respective product, each RF emitter to output an RF signal that includes at least data representative of a unique identifier logically associated with a respective one of the plurality of products; where the output signal produced by the RF device includes data representative of one or more of: the unique identifier associated with a respective one of the plurality of products; a strength of an RF signal received from the RF emitter coupled to the respective one or the plurality of products; or a phase of the RF signal received from an RF emitter coupled to the respective one or the plurality of products; and detecting, by the targeted offer distribution circuitry one or more changes in the received RF signal, the one or more changes in the received RF signal attributable to customer interaction with the at least one product.

Example 14 may include elements of example 11, and the method may additionally include: generating an output signal indicative of at least one of: a customer's movement or a customer's location within one or more areas of the retail environment by a regional monitoring system communicably coupled to the targeted offer distribution circuitry; and causing, by the targeted offer distribution circuitry, the customer interest monitoring device to generate the output signal responsive to a determination that the customer has remained in an area of the retail environment for a time exceeding a defined temporal threshold.

Example 15 may include elements of example 11 where delivering the temporally limited offer via an output device may include: delivering the temporally limited offer via an output device comprising digital signage proximate the one or more products.

Example 16 may include elements of example 11 where delivering the temporally limited offer via an output device may include: delivering the temporally limited offer via an output device comprising a coupon dispenser proximate the one or more products.

Example 17 may include elements of example 11 where delivering the temporally limited offer via an output device may include: delivering the temporally limited offer via an output device comprising a processor-based device possessed by the customer.

Example 18 may include elements of example 11, and the method may additionally include: uniquely identifying the customer by a customer identification device communicably coupled to the targeted offer distribution circuitry; retrieving, by the targeted offer distribution circuitry, demographic information about the customer; where generating a temporally limited offer directed to at least some of the one or more products based on the detected customer interaction with the one or more products further comprises: generating a temporally limited offer directed to at least some of the one or more products based on the detected customer interaction with the one or more products and based on the retrieved demographic information.

Example 19 may include elements of example 18 where uniquely identifying the customer by a customer identification device may include: uniquely identifying the customer by a customer identification device that uniquely identifies the customer using a radio frequency identification (RFID) tag embedded in an product possessed by the customer.

Example 20 may include elements of example 18 where uniquely identifying the customer by a customer identification device may include: uniquely identifying the customer by a customer identification device that uniquely identifies the customer using a processor-based handheld device carried by the customer.

According to example 21, there is provided a non-transitory computer-readable medium containing machine-executable instructions that, when executed by controller circuitry, cause the controller circuitry to transition to targeted offer distribution circuitry, the targeted offer distribution circuitry to: receive an output signal that includes information indicative of customer browsing of products in a retail environment, the output signal generated by a communicably coupled customer interest monitoring device; detect customer interaction with one or more products using the information included in the customer interest monitoring device output signal; generate a temporally limited offer directed to at least some of the one or more products based on the detected customer interaction with the one or more products; and cause a communicably coupled display device to display the temporally limited offer.

Example 22 may include elements of example 21 where the machine-readable instructions that cause the targeted offer distribution circuitry to receive an output signal that includes information indicative of customer browsing of products in a retail environment may cause the targeted offer distribution circuitry to: receive an output signal that includes information indicative of customer browsing of products in a retail environment from a customer interest monitoring device that includes an image acquisition device; where the received output signal includes data representative of one or more images obtained by the image acquisition device.

Example 23 may include elements of example 21 where the machine-readable instructions that cause the targeted offer distribution circuitry to receive an output signal that includes information indicative of customer browsing of products in a retail environment may cause the targeted offer distribution circuitry to: receive an output signal that includes information indicative of customer browsing of products in a retail environment from a customer interest monitoring device that includes a radio frequency (RF) device; where each of the one or more products includes a respective RF emitter coupled to the respective product, each RF emitter to output an RF signal that includes at least data representative of a unique identifier logically associated with a respective one of the plurality of products; where the output signal produced by the RF device includes data representative of one or more of: the unique identifier associated with a respective one of the plurality of products; a strength of an RF signal received from the RF emitter coupled to the respective one or the plurality of products; or a phase of the RF signal received from an RF emitter coupled to the respective one or the plurality of products; and detect one or more changes in the received RF signal, the one or more changes in the received RF signal attributable to customer interaction with at least one product.

Example 24 may include elements of example 21 where the machine-readable instructions that cause the targeted offer distribution circuitry to receive an output signal that includes information indicative of customer browsing of products in a retail environment may further cause the targeted offer distribution circuitry to: receive an output signal indicative of a customer's location within one or more portions of the retail environment by a regional monitoring system communicably coupled to the targeted offer distribution circuitry; and cause the customer interest monitoring device to generate the output signal responsive to a determination that the customer has remained in a portion of the retail environment for a time exceeding a defined temporal threshold.

Example 25 may include elements of example 21 where the machine-readable instructions that cause the targeted offer distribution circuitry to cause a communicably coupled display device to display the temporally limited offer displaying the temporally limited offer on a display device may further cause the targeted offer distribution circuitry to: cause a communicably coupled display device to display the temporally limited offer displaying the temporally limited offer on a display device comprising digital signage proximate the one or more products.

Example 26 may include elements of example 21 where the machine-readable instructions that cause the targeted offer distribution circuitry to cause a communicably coupled display device to display the temporally limited offer displaying the temporally limited offer on a display device may further cause the targeted offer distribution circuitry to: cause a communicably coupled display device to display the temporally limited offer displaying the temporally limited offer on a display device comprising a coupon dispenser proximate the one or more products.

Example 27 may include elements of example 21 where the machine-readable instructions that cause the targeted offer distribution circuitry to cause a communicably coupled display device to display the temporally limited offer displaying the temporally limited offer on a display device may further cause the targeted offer distribution circuitry to: cause a communicably coupled display device to display the temporally limited offer displaying the temporally limited offer on a display device comprising a processor-based device possessed by the customer.

Example 28 may include elements of example 21 where the machine-readable instructions may further cause the targeted offer distribution circuitry to: uniquely identify the customer using a customer identification device possessed by the customer and communicably coupled to the targeted offer distribution circuitry; retrieve demographic information about the customer; where the machine-readable instructions that cause the targeted offer distribution circuitry to generate a temporally limited offer directed to at least some of the one or more products based on the detected customer interaction with the one or more products may further cause the targeted offer distribution circuitry to: generate a temporally limited offer directed to at least some of the one or more products based on the detected customer interaction with the one or more products and based on the retrieved demographic information.

Example 29 may include elements of example 28 where the machine-readable instructions that cause the targeted offer distribution circuitry to uniquely identify the customer by a customer identification device may further cause the targeted offer distribution circuitry to: uniquely identify the customer using a customer identification device that uniquely identifies the customer using a radio frequency identification (RFID) tag embedded in an product carried by the customer.

Example 30 may include elements of example 28 where the machine-readable instructions that cause the targeted offer distribution circuitry to uniquely identify the customer by a customer identification device may further cause the targeted offer distribution circuitry to: uniquely identify the customer using a customer identification device that uniquely identifies the customer using a processor-based handheld device carried by the customer.

According to example 31, there is provided a targeted offer distribution system. The system may include: a means for generating an output signal that includes information indicative of customer browsing of products in a retail environment; a means for detecting customer interaction with one or more products using the information included in the customer interest monitoring device output signal; a means for generating a temporally limited offer directed to at least some of the one or more products based on the detected customer interaction with the one or more products; and a means for delivering the temporally limited offer to the customer.

Example 32 may include elements of example 31 where the means for generating an output signal that includes information indicative of customer browsing of products in a retail environment may include: a means for generating an output signal that includes information indicative of customer browsing of products in a retail environment using an image acquisition means; wherein the output signal includes data representative of one or more images obtained by the image acquisition means.

Example 33 may include elements of example 31 where the means for generating an output signal that includes information indicative of customer browsing of products in a retail environment by a customer interest monitoring device may further comprise: a means for generating an output signal that includes information indicative of customer browsing of products in a retail environment by a customer interest monitoring device that includes a radio frequency (RF) device; wherein each of the one or more products includes a respective RF emitter coupled to the respective product, each RF emitter to output an RF signal that includes at least data representative of a unique identifier logically associated with a respective one of the plurality of products; wherein the output signal produced by the RF device includes data representative of one or more of: the unique identifier associated with a respective one of the plurality of products; a strength of an RF signal received from the RF emitter coupled to the respective one or the plurality of products; or a phase of the RF signal received from an RF emitter coupled to the respective one or the plurality of products; and a means for detecting, by the targeted offer distribution circuitry one or more changes in the received RF signal, the one or more changes in the received RF signal attributable to customer interaction with the at least one product.

Example 34 may include elements of example 31, and the system may additionally include: a means for generating an output signal indicative of a customer's location within one or more portions of the retail environment; and a means for causing the generation of the output signal responsive to a determination that the customer has remained in a portion of the retail environment for a time exceeding a defined temporal threshold.

Example 35 may include elements of example 31 where the means for delivering the temporally limited offer may include: a means for delivering the temporally limited offer to a display means proximate the one or more products.

Example 36 may include elements of example 31 where the means for delivering the temporally limited offer may include: a means for delivering the temporally limited offer to a coupon dispensing means proximate the one or more products.

Example 37 may include elements of example 31 where the means for delivering the temporally limited offer may include: a means for delivering the temporally limited offer to a processor-based device means possessed by the customer.

Example 38 may include elements of example 31, and the system may additionally include: a means for uniquely identifying the customer; a means for retrieving demographic information about the customer; where the means for generating a temporally limited offer directed to at least some of the one or more products based on the detected customer interaction with the one or more products may further include: a means for generating a temporally limited offer directed to at least some of the one or more products based on the detected customer interaction with the one or more products and based on the retrieved demographic information.

Example 39 may include elements of example 38 where the means for uniquely identifying the customer by a customer identification device may include: a means for uniquely identifying the customer using a customer identification means that includes a radio frequency identification (RFID) tag.

Example 40 may include elements of example 38 where the means for uniquely identifying the customer by a customer identification device may include: a means for uniquely identifying the customer using a customer identification means that includes a processor-based handheld device possessed by the customer.

According to example 41, there is provided a targeted offer distribution system being arranged to perform the method of any of examples 11 through 20.

According to example 42, there is provided a chipset arranged to perform the method of any of examples 11 through 20.

According to example 43, there is provided a non-transitory machine readable medium comprising a plurality of instructions that, in response to be being executed on a computing device, cause the computing device to carry out the method according to any of examples 11 through 20.

According to example 44, there is provided a targeted offer distribution device being arranged to perform the method of any of examples 11 through 20.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A targeted offer distribution system, comprising:
a customer interest monitoring device to generate an output signal that includes information indicative of customer browsing of products in a retail environment;
an output device;
controller circuitry communicably coupled to the customer interest monitoring device and to the display device; and
a storage device containing machine-executable instructions, that when executed by the controller circuitry, transform the controller circuitry to targeted offer distribution circuitry, the targeted offer distribution circuitry to:
detect customer interaction with one or more products using the information included in the customer interest monitoring device output signal;
generate a targeted offer based at least in part on the detected customer interaction with the one or more products, the targeted offer including at least one of: a temporally limited targeted offer or a non-transferrable targeted offer; and
deliver the targeted offer to the output device.

2. The targeted offer distribution system of claim 1 wherein the customer interest monitoring device includes an image acquisition device and the output signal includes data representative of one or more images obtained by the image acquisition device.

3. The targeted offer distribution system of claim 1:
wherein the customer interest monitoring device includes a radio frequency (RF) device;
wherein each of the one or more products includes a respective RF emitter coupled to the respective product, each RF emitter to output an RF signal that includes at least data representative of a unique identifier logically associated with a respective one of the plurality of products;
wherein the output signal produced by the RF device includes data representative of one or more of: the unique identifier associated with a respective one of the plurality of products; a strength of an RF signal received from the RF emitter coupled to the respective one or the plurality of products; or a phase of the RF signal received from an RF emitter coupled to the respective one or the plurality of products; and
wherein the machine-executable instructions further cause the targeted offer distribution circuitry to:
detect one or more changes in the received RF signal, the one or more changes in the received RF signal attributable to customer interaction with the one or more products.

4. The targeted offer distribution system of claim 1, further comprising:
a regional monitoring system communicably coupled to the controller circuitry, the regional monitoring system to generate an output signal indicative of at least one of: a customer's movement or a customer's location within one or more portions of the retail environment;
wherein the machine-executable instructions further cause the targeted offer distribution circuitry to cause the customer interest monitoring device to generate the output signal responsive to a determination that the customer has remained in a defined area of the retail environment for a time that exceeds a defined temporal threshold.

5. The targeted offer distribution system of claim 1 wherein the output device comprises digital signage proximate the one or more products.

6. The targeted offer distribution system of claim 1 wherein the output device comprises a coupon dispenser proximate the one or more products.

7. The targeted offer distribution system of claim 1 wherein the output device comprises a processor-based device possessed by the customer.

8. The targeted offer distribution system of claim 1, further comprising:
a customer identification device to uniquely identify the customer in the retail establishment and retrieve demographic information about the customer;
wherein the customer identification device retrieves the demographic information associated with the customer responsive to uniquely identifying the customer; and
wherein the machine-executable instructions that cause the targeted offer distribution circuitry to deliver a temporally limited offer based on the detected customer interaction with the one or more products further cause the targeted offer distribution circuitry to:
deliver a temporally limited offer based on the detected customer interaction with the one or more products and based on the retrieved demographic information.

9. The targeted offer distribution system of claim 8 wherein the customer identification device uniquely identifies the customer using a radio frequency identification (RFID) tag embedded in an product possessed by the customer.

10. The targeted offer distribution system of claim 8 wherein the customer identification device uniquely identifies the customer using a processor-based handheld device possessed by the customer.

11. A targeted offer distribution method, comprising:
generating an output signal that includes information indicative of customer browsing of products in a retail environment by a customer interest monitoring device;
detecting customer interaction with one or more products using the information included in the customer interest monitoring device output signal by targeted offer distribution circuitry communicably coupled to the customer interest monitoring device;
generating, by the targeted offer distribution circuitry, a temporally limited offer directed to at least one product based on the detected customer interaction with the one or more products; and
delivering the temporally limited offer via an output device communicably coupled to the targeted offer distribution circuitry.

12. The targeted offer distribution method of claim 11 wherein generating an output signal that includes information indicative of customer browsing of products in a retail environment by a customer interest monitoring device comprises:
generating an output signal that includes information indicative of customer browsing of products in a retail environment by a customer interest monitoring device that includes an image acquisition device;
wherein the output signal includes data representative of one or more images obtained by the image acquisition device.

13. The targeted offer distribution method of claim 11 wherein generating an output signal that includes information indicative of customer browsing of products in a retail environment by a customer interest monitoring device comprises:
generating an output signal that includes information indicative of customer browsing of products in a retail environment by a customer interest monitoring device that includes a radio frequency (RF) device;
wherein each of the one or more products includes a respective RF emitter coupled to the respective product, each RF emitter to output an RF signal that includes at least data representative of a unique identifier logically associated with a respective one of the plurality of products;
wherein the output signal produced by the RF device includes data representative of one or more of: the unique identifier associated with a respective one of the plurality of products; a strength of an RF signal received from the RF emitter coupled to the respective one or the plurality of products; or a phase of the RF signal received from an RF emitter coupled to the respective one or the plurality of products; and
detecting, by the targeted offer distribution circuitry one or more changes in the received RF signal, the one or more changes in the received RF signal attributable to customer interaction with the at least one product.

14. The targeted offer distribution method of claim 11, further comprising:
generating an output signal indicative of at least one of: a customer's movement or a customer's location within one or more areas of the retail environment by a regional monitoring system communicably coupled to the targeted offer distribution circuitry; and
causing, by the targeted offer distribution circuitry, the customer interest monitoring device to generate the output signal responsive to a determination that the customer has remained in an area of the retail environment for a time exceeding a defined temporal threshold.

15. The targeted offer distribution method of claim 11 wherein delivering the temporally limited offer via an output device comprises:
delivering the temporally limited offer via an output device comprising digital signage proximate the one or more products.

16. The targeted offer distribution method of claim 11 wherein delivering the temporally limited offer via an output device comprises:
delivering the temporally limited offer via an output device comprising a coupon dispenser proximate the one or more products.

17. The targeted offer distribution method of claim 11 wherein delivering the temporally limited offer via an output device comprises:
delivering the temporally limited offer via an output device comprising a processor-based device possessed by the customer.

18. The targeted offer distribution method of claim 11, further comprising:
uniquely identifying the customer by a customer identification device communicably coupled to the targeted offer distribution circuitry; and
retrieving, by the targeted offer distribution circuitry, demographic information about the customer;
wherein generating a temporally limited offer directed to at least some of the one or more products based on the detected customer interaction with the one or more products further comprises:
generating a temporally limited offer directed to at least some of the one or more products based on the detected customer interaction with the one or more products and based on the retrieved demographic information.

19. The targeted offer distribution method of claim 18 wherein uniquely identifying the customer by a customer identification device comprises:
uniquely identifying the customer by a customer identification device that uniquely identifies the customer using a radio frequency identification (RFID) tag embedded in an product possessed by the customer.

20. The targeted offer distribution method of claim 18 wherein uniquely identifying the customer by a customer identification device comprises:
uniquely identifying the customer by a customer identification device that uniquely identifies the customer using a processor-based handheld device carried by the customer.

21. A non-transitory computer-readable medium containing machine-executable instructions that, when executed by controller circuitry, cause the controller circuitry to transition to targeted offer distribution circuitry, the targeted offer distribution circuitry to:
receive an output signal that includes information indicative of customer browsing of products in a retail environment, the output signal generated by a communicably coupled customer interest monitoring device;
detect customer interaction with one or more products using the information included in the customer interest monitoring device output signal;
generate a temporally limited offer directed to at least some of the one or more products based on the detected customer interaction with the one or more products; and
cause a communicably coupled display device to display the temporally limited offer.

22. The non-transitory computer-readable medium of claim 21 wherein the machine-readable instructions that cause the targeted offer distribution circuitry to receive an output signal that includes information indicative of customer browsing of products in a retail environment cause the targeted offer distribution circuitry to:
receive an output signal that includes information indicative of customer browsing of products in a retail environment from a customer interest monitoring device that includes an image acquisition device;
wherein the received output signal includes data representative of one or more images obtained by the image acquisition device.

23. The non-transitory computer-readable medium of claim 21 wherein the machine-readable instructions that cause the targeted offer distribution circuitry to receive an output signal that includes information indicative of customer browsing of products in a retail environment cause the targeted offer distribution circuitry to:
receive an output signal that includes information indicative of customer browsing of products in a retail environment from a customer interest monitoring device that includes a radio frequency (RF) device;
wherein each of the one or more products includes a respective RF emitter coupled to the respective product, each RF emitter to output an RF signal that includes at least data representative of a unique identifier logically associated with a respective one of the plurality of products;
wherein the output signal produced by the RF device includes data representative of one or more of: the unique identifier associated with a respective one of the plurality of products; a strength of an RF signal received from the RF emitter coupled to the respective one or the plurality of products; or a phase of the RF signal received from an RF emitter coupled to the respective one or the plurality of products; and
detect one or more changes in the received RF signal, the one or more changes in the received RF signal attributable to customer interaction with at least one product.

24. The non-transitory computer readable medium of claim 21 wherein the machine-readable instructions that cause the targeted offer distribution circuitry to receive an output signal that includes information indicative of customer browsing of products in a retail environment further cause the targeted offer distribution circuitry to:
receive an output signal indicative of a customer's location within one or more portions of the retail environment by a regional monitoring system communicably coupled to the targeted offer distribution circuitry; and
cause the customer interest monitoring device to generate the output signal responsive to a determination that the customer has remained in a portion of the retail environment for a time exceeding a defined temporal threshold.

25. The non-transitory computer-readable medium of claim 21 wherein the machine-readable instructions that cause the targeted offer distribution circuitry to cause a communicably coupled display device to display the temporally limited offer displaying the temporally limited offer on a display device further cause the targeted offer distribution circuitry to:
cause a communicably coupled display device to display the temporally limited offer displaying the temporally limited offer on a display device comprising digital signage proximate the one or more products.
